(19) United States
(12) Patent Application Publication
(10) Pub. No.: US 2026/0169514 A1
(43) Pub. Date: Jun. 18, 2026

(54) DIFFERENTIABLE SENSITIVITY-BASED SKEW SCHEDULING FRAMEWORK FOR TIMING OPTIMIZATION

(71) Applicant: NVIDIA Corporation, Santa Clara, CA (US)

(72) Inventors: Sheena Chang, Taipei City (TW); Wen-Hao Liu, Hsinchu City (TW); Yi-Chen Lu, San Jose, CA (US); Anand Rajaram, Austin, TX (US); Haoxing Ren, Austin, TX (US)

(21) Appl. No.: 19/224,351

(22) Filed: May 30, 2025

Related U.S. Application Data
(60) Provisional application No. 63/734,529, filed on Dec. 16, 2024.

(51) Int. Cl. G06F 1/04

(52) U.S. Cl. CPC G06F 1/04

(57) ABSTRACT

Embodiments of the present disclosure provide systems and methods for clock latency adjustment. A clock latency set and a timing report are obtained, and based on the clock latency set and the timing report, a set of critical registers are identified. An initial clock latency adjustment procedure is performed to provide a latency adjustment for one or more registers in the set of critical registers. Pursuant to a zero-mean constraint, the one or more latency adjustments are modified. The modified one or more latency adjustments are used to adjust one or more latencies in the clock latency set.

### CLAIM OF PRIORITY

This application claims the benefit of U.S. Provisional Application No. 63/734,529 titled “Differentiable Sensitivity-Based Skew Scheduling Framework For Timing Optimization,” filed Dec. 16, 2024, the entire contents of which is incorporated herein by reference.

### BACKGROUND

As integrated circuits become more complex and scale up in size, effectively addressing timing violations becomes essential to ensure robust performance and meet stringent design specifications. However, due to higher clock frequencies, reduced timing margins, and growing process variations, timing closure has become an increasingly difficult challenge in modern chip design.

Clock skew optimization is a widely used technique to tackle timing issues by adjusting the arrival times of clock signals at various registers. Traditionally, clock skew optimization involves two primary steps: first, performing zero-skew clock tree synthesis (CTS), and second, adjusting the clock skews at individual registers. Traditional useful-skew optimization, which is applied after CTS, is a widely adopted technique to manage timing challenges by adjusting clock latencies. However, useful-skew limits the optimization space and often leads to suboptimal results. Early work formulated the clock skew optimization problem as a Linear Programming (LP) problem, while other approaches construct a timing graph and map the useful skew optimization problem to a maximum mean weight cycle (MMWC) problem. However, timing graph construction often lacks physical design information, leading to results that may not align with practical implementation considerations. Furthermore, by considering only the most critical path between pairs of flip-flops, the cumulative effect of multiple less critical paths is not considered, potentially leading to suboptimal Total Negative Slack (TNS) optimization across the entire design.

More recent work has proposed a reinforcement learning (RL)-based endpoint prioritization approach, selecting critical endpoints for Electronic Design Automation (EDA) tools to overfix, leading to improved TNS during the post-placement stage. This method does not account for TNS at later stages such as CTS and routing, potentially leaving timing violations unresolved in these phases and necessitating manual interventions, through an iterative process, to achieve timing closure. However, the process of manually adjusting constraints and re-running design steps is time-consuming and inefficient, often leading to increased design cycles and delayed time-to-market. This highlights the need for an automated, holistic approach to timing optimization that addresses violations across all design stages.

### SUMMARY

Embodiments of the present disclosure provide systems and methods for clock latency adjustment. In at least one embodiment, a clock latency set and a timing report are obtained. Based on the clock latency set and the timing report, a set of critical registers are identified. An initial clock latency adjustment procedure is performed to provide, for one or more critical registers in the set of critical registers, a latency adjustment. Pursuant to a zero-mean constraint, the one or more latency adjustments are modified. Using the one or more modified latency adjustments, one or more latencies in the clock latency set are adjusted to provide a new clock latency set.

In at least another embodiment, a clock latency set including a latency for one or more registers in a chip design is obtained. A timing metric function of the clock latency set is obtained. The clock latency set is updated to provide a new clock latency set by performing, for each of one or more iterations, computation of a gradient of the timing metric function with respect to one or more latencies in the clock latency set, computation, based on the one or more computed gradients, of a clock latency adjustment for the one or more latencies in the clock latency set, and adjustment, using the one or more computed clock latency adjustments, of the one or more latencies in the clock latency set to provide the new clock latency set.

### BRIEF DESCRIPTION OF THE DRAWINGS

Subject matter of the present disclosure is described in detail below with reference to the attached drawing figures. Features described and/or illustrated herein can be used alone and/or combined in different combinations. The attached drawings illustrate the following:

FIG. 1A illustrates a flowchart of a method for implementing a heuristic-based zero-mean shifting technique, in accordance with one or more embodiments;

FIG. 1B illustrates a place-and-route design flow of electronic design automation (EDA) using a commercial EDA tool that incorporates a heuristic-based zero-mean shifting technique, in accordance with one or more embodiments;

FIG. 2A illustrates a flowchart of a method for implementing a differentiable sensitivity-based skew scheduling (DSSS) technique, in accordance with one or more embodiments;

FIG. 2B illustrates an algorithm used to implement the differentiable sensitivity-based skew scheduling (DSSS) technique, in accordance with one or more embodiments;

FIGS. 2C-2F illustrate a place-and-route design flow of electronic design automation (EDA) using a commercial EDA tool that incorporates the differentiable sensitivity-based skew scheduling (DSSS) technique, in accordance with one or more embodiments;

FIGS. 3A-3B illustrate clock skew in a synchronous digital circuit;

FIG. 4 is a conceptual diagram of a processing system implemented using a PPU, suitable for use in implementing one or more embodiments;

FIG. 5A illustrates an exemplary system in which the various architectures and/or functionality of the various previous embodiments may be implemented;

FIG. 5B illustrates components of an exemplary system that can be used to train and utilize machine learning, according to one or more embodiments; and

FIG. 6 illustrates an exemplary streaming system suitable for use in implementing one or more embodiments.

### DETAILED DESCRIPTION

As digital circuits become increasingly complex, incorporating billions of transistors, deep logic pipelines, and multiple clock domains, the process of designing digital circuits has outgrown what manual methods or simple tools can handle. Electronic Design Automation (EDA) tools are used to automate the design, analysis, and verification of complex electronic systems, such as integrated circuits (ICs) and printed circuit boards (PCBs). EDA tools automate critical design steps including logic synthesis, simulation, placement and routing, timing analysis, and verification, enabling engineers to create highly integrated and efficient digital systems—from embedded processors to full system-on-chip (SoC) designs. A central stage in this process is place and route, where logical components are physically arranged (placed) and interconnected with wires (routed) on a silicon die. Place and route aims to optimize for timing, power, area, and manufacturability, ensuring the digital circuit design meets performance goals.

In synchronous digital systems, precise timing coordination among logic components is essential to ensure correct functionality. Clock signals are crucial for providing a consistent and synchronized timing reference for all sequential operations and for ensuring that data is transferred, processed, and stored in a controlled and predictable manner. Clock signals can be, e.g., a periodic square wave that alternates between high and low voltage levels, and digital components such as flip-flops, registers, and counters use the rising or falling edge to determine when to update their states.

Timing checks, which include a setup time and a hold time, ensure that data is valid and stable at the right moments. Setup time requires that data be stable for a certain period before the active clock edge (e.g., rising or falling clock edge), while hold time ensures data remains stable for a period after the active clock edge. These timing checks prevent errors such as data corruption or metastability, which can disrupt system behavior. By enforcing these constraints, timing checks ensure that the synchronization provided by the clock signal leads to predictable and reliable operation throughout the digital circuit.

When elements of a synchronous digital circuit, such as logic gates, flip-flops, and interconnects, work together in a complex design, timing violations can arise due to varying path delays. Timing violations occur when data fails to meet setup or hold time requirements relative to the clock signal at a receiving synchronous digital circuit element (e.g., a flip-flop). Two key metrics are used to assess whether a synchronous digital circuit design meets timing requirements: Worst Negative Slack (WNS) and Total Negative Slack (TNS).

Worst Negative Slack (WNS) refers to the single most critical timing violation in the entire design of the synchronous digital circuit. WNS is the largest amount of time by which a signal path misses its required setup time. A large WNS indicates a deeply problematic path that prevents the circuit from operating correctly at the target clock frequency. This is often the first target for timing optimization, as it highlights the most urgent and performance-limiting bottleneck.

Total Negative Slack (TNS), on the other hand, is the sum of all timing violations across all failing paths in the design of the synchronous digital circuit. It provides a broader view of how widespread timing violations are. While WNS highlights the worst-case path, TNS indicates the overall timing health of the circuit. A high TNS suggests that many paths are failing, even if none are failing by a large amount individually.

During electronic design automation (EDA), place and route tools are often used to detect timing violations through static timing analysis (STA). Upon detection, such timing violations can be remedied to achieve timing closure.

One technique to remedy timing violations is to introduce clock skew in elements of the synchronous digital circuits that are involved in a timing violation. Introducing clock skew involves intentionally adjusting the arrival time of the clock signal at a synchronous digital circuit element to help incoming data at the synchronous digital circuit element meet setup and hold time requirements by compensating for path delays. However, introducing clock skews can lead to an increase in design complexity of the synchronous digital circuit. Therefore, the introduction of clock skew in a circuit is optimized to strike a balance between timing violations occurring across thousands or even millions of paths in a chip and complexity of design.

Traditionally, clock skew optimization involves two primary steps: performing zero-skew clock tree synthesis (CTS) and subsequently adjusting the clock skews at registers. However, clock skew optimization is traditionally formulated as a linear programming problem and has significant drawbacks. Traditional methods for clock skew optimization involve invasive changes after routing, introduce new timing violations elsewhere, and increase the complexity, power, and area of the clock network. Furthermore, most EDA tools rely on local heuristics for skew tuning, which can miss global optimization opportunities. Fixed skew values used to optimize clock skews also limit post-silicon adaptability, leaving designs vulnerable to variations in manufacturing or operating conditions. These limitations highlight the need for more intelligent, flexible, and predictive approaches to clock skew management within the digital design flow.

The present disclosure provides systems and methods for achieving timing optimization in the design of complex digital circuits. In one or more embodiments, systems and methods utilize the gradients of TNS with respect to individual clock latencies in a gradient-based optimization to find clock latency assignments associated with individual elements of synchronous digital circuits.

According to one or more embodiments, the present disclosure provides a zero-mean shifting technique for clock latency adjustment, which achieves notable improvements over default commercial tools. According to one or more embodiments, the zero-mean shifting technique is a heuristic-based approach to adjusting clock latencies to improve timing performance. According to one or more embodiments, the zero-mean shifting technique modifies the clock latencies of critical registers involved in timing violations such that the mean of the adjustments is zero, thereby helping prevent large skew imbalances that could degrade the performance of other timing paths and maintaining a stable adjustment profile while effectively addressing critical paths.

According to one or more embodiments, the present disclosure provides a Differentiable Sensitivity-Based Skew Scheduling (DSSS) technique that utilizes sensitivity analysis for informed clock latency adjustments and leverages gradient-based optimization to systematically reduce (e.g., minimize) timing metrics (e.g., TNS, Worst Negative Slack (WNS), or a composition of TNS and WNS). According to one or more embodiments, DSSS leverages differentiable sensitivity analysis, utilizing the sensitivity of timing metrics (e.g., TNS) with respect to individual clock latencies, enabling informed and proportional adjustments to be made to said clock latencies. According to one or more embodiments, by modeling the relationship between clock latencies and timing metrics in a differentiable manner, gradient-based optimization can iteratively update clock latencies and efficiently navigate the solution space to identify a solution, e.g., one that minimizes both TNS and WNS.

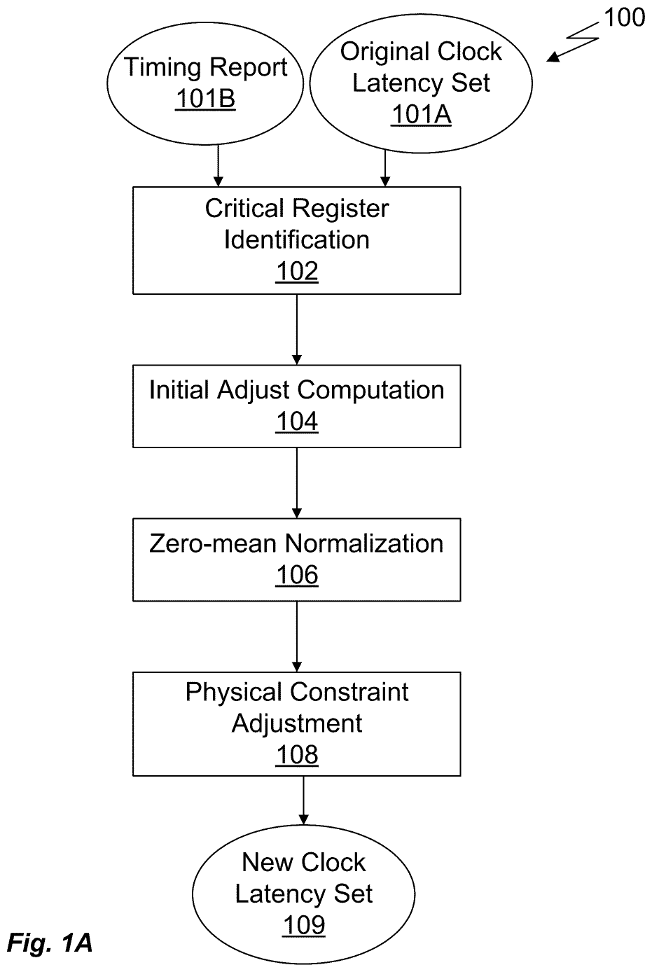

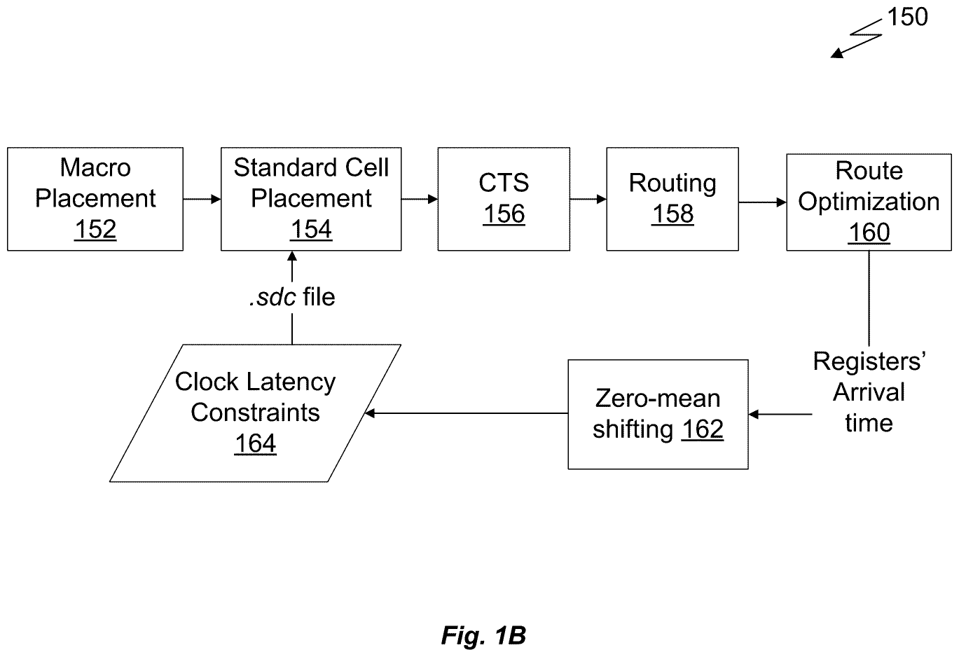

FIG. 1A illustrates a flowchart of a process 100 for implementing a heuristic-based zero-mean shifting technique, in accordance with an embodiment of the present disclosure. Each block of process 100, described herein, comprises a computing process that may be performed using any combination of hardware, firmware, and/or software. For instance, various functions may be carried out by a processor executing instructions stored in memory. The process may also be embodied as computer-usable instructions stored on computer storage media. The process may be provided by a standalone application, a service or hosted service (standalone or in combination with another hosted service), or a plug-in to another product, to name a few. However, this process may additionally or alternatively be executed by any one system, or any combination of systems, including, but not limited to, those described herein. Furthermore, persons of ordinary skill in the art will understand that any system that performs process 100 is within the scope and spirit of embodiments of the present disclosure.

Process 100 receives, as input, an original clock latency set 101A and a timing report 101B. The original clock latency set 101A provides clock latencies L=[L₁, L₂, . . . , L_{N}]^{T} for N registers present in a chip design. At 102, the process identifies, based on the original clock latency set 101A and the timing report 101B, critical registers, i.e., registers involved in timing-violated paths as either launching or capturing registers. The identified critical registers are the focus of subsequent clock latency adjustments.

At 104, process 100 performs an initial adjustment computation. The initial adjustment computation includes computing, for each critical register i (identified at 102), an initial clock latency adjustment ΔLᵢ based on the negative slack of its associated timing paths. The initial adjustments aim to alleviate timing violations by advancing or delaying the clock arrival times appropriately.

At 106, the process performs zero-mean normalization, in which the adjustments ΔLᵢ computed at 104 are modified so ensure that their mean is zero. Specifically, the adjustments ΔLᵢ are modified to provide normalized adjustments ΔLᵢ′ according to:

$$Δ {L}_{i}^{′} = Δ {L}_{i} - \frac{1}{{N}_{c}} {\sum }_{j = 1}^{{N}_{c}} Δ {L}_{j} ,$$

where N_{c} is the number of critical registers. This step balances the increases and decreases in clock latencies, preventing large skew imbalances that could affect other timing paths.

At 108, the process performs a physical constraint adjustment to ensure that the normalized adjustments ΔLᵢ′ computed at 106 are feasible. Specifically, at 108, the normalized adjustments ΔLᵢ′ computed at 106 are subjected to latency bounds and timing relationship requirements. To subject the normalized adjustments ΔLᵢ′ to latency bounds, they must satisfy:

$${L}_{i}^{min} \leq {L}_{i} + Δ {L}_{i}^{′} \leq {L}_{i}^{max} , ∀ i ,$$

where

$${L}_{i}^{min} and {L}_{i}^{max}$$

are the minimum and maximum allowable clock latencies for register i. If an adjusted latency violates these bounds, the normalized adjustments ΔLᵢ′ is modified to ensure that the adjusted latency Lᵢ+ΔLᵢ′ matches the nearest feasible value. To subject the normalized adjustments ΔLᵢ′ to timing relationship requirements, the required timing relationships between registers is considered. For example, the clock latency of a capturing register should be greater than or equal to that of its launching registers to prevent hold time violations, i.e., L_{capturing}≥max(L_{launching_registers})). If an adjusted latency results in a violation of a required timing relationship, the normalized adjustment ΔLᵢ′ is modified to eliminate the violation.

Following the physical constraint adjustment at 108, each resulting adjustments

$$Δ {L}_{i}^{″}$$

is added to the corresponding latency Lᵢ to provide a new clock latency set 109, which includes new clock latencies

$${L}_{i}^{new} = {L}_{i} + Δ {L}_{i}^{″} .$$

The new clock latency set 109 thus provides

$$L = {[ {L}_{1}^{new} , {L}_{2}^{new} , … , {L}_{N}^{new} ]}^{T}$$

clock latencies for the N registers in the chip design.

In various embodiments, process 100 is performed in the context of a “place-and-route” design flow of an electronic design automation (EDA) process, e.g., as carried out using a commercial EDA tool. In at least one embodiment, process 100 is performed in the context of the “place-and-route” design flow illustrated in FIG. 1B.

FIG. 1B illustrates a process 150 for implementing a place-and-route (PnR) stage of an electronic design automation (EDA) process for transforming a logical circuit design into a physical layout that can be manufactured on silicon, in accordance with an embodiment. Each block of process 150, described herein, comprises a process that may be performed, e.g., using any combination of hardware, firmware, and/or software. For instance, various functions may be carried out by a processor executing instructions stored in memory. The process may also be embodied as computer-usable instructions stored on computer storage media. The process may be provided by a standalone application, a service or hosted service (standalone or in combination with another hosted service), or a plug-in to another product, to name a few. However, this process may additionally or alternatively be executed by any one system, or any combination of systems, including, but not limited to, those described herein. Furthermore, persons of ordinary skill in the art will understand that any system that performs process 150 is within the scope and spirit of embodiments of the present disclosure.

Process 150 includes (i) macro placement, (ii) standard cell placement, (iii) clock tree synthesis (CTS), (iv) routing, and (v) route optimization. Process 150 can be, e.g., part of an electronic design automation (EDA) process carried out using a commercial EDA tool that incorporates a heuristic-based zero-mean shifting technique, e.g., as implemented via process 100.

At 152, process 150 includes macro placement. Macro placement involves determining the physical locations of large components, known as macros, on a chip during its design phase. Macros include memory blocks (e.g., SRAM, DRAM, and ROM, optimized for storage and retrieval), processor cores (e.g., pre-designed cores for CPUs or GPUs), analog components like clock generators, and other large functional units that are significantly larger than standard cells. Macro placement directly impacts key chip performance metrics including, e.g., power consumption, performance, chip area utilization efficiency, and routability.

At 154, process 150 includes standard cell placement. Standard cell placement involves determining the physical locations of standard cells, which are the smaller building blocks of digital designs. Standard cells are pre-designed and pre-characterized blocks of logic functions, including, e.g., AND, OR, XOR gates, storage elements like flip-flops and latches, etc. Standard cell placement aims to ensure efficient use of chip area, minimize interconnect delays and power consumption, and prepare the layout for the subsequent routing and timing closure stages.

At 156, process 150 includes clock tree synthesis (CTS). CTS involves designing and optimizing the clock distribution network in a chip during the physical design phase of electronic design automation (EDA). The clock network ensures that the clock signal reaches all sequential elements, such as flip-flops and latches, with minimal skew and optimal latency, enabling synchronous operation across the chip. CTS aims to minimize clock skew by ensuring that the clock signal arrives at all endpoints simultaneously or within acceptable timing limits to avoid synchronization issues, reduce insertion delay by optimizing the delay between the clock source and its endpoints, maximize power efficiency, e.g., by using techniques such as clock gating to save dynamic power by disabling clocks to inactive modules, and ensure design rule compliance.

At 158, process 150 performs routing, and at 160, process 150 performs route optimization. Routing and route optimization follow CTS and create and refine the physical connections between components to ensure proper functionality, signal integrity, and adherence to design constraints. In at least one embodiment, routing at 158 involves connecting the terminals (pins) of placed components or cells on a chip using wires (metal traces) and aims to ensure that all nets (groups of pins that need to be electrically connected) are properly connected while obeying design rules. In at least one embodiment, route optimization at 160 involves further refining the routing topology and addressing issues that arise during routing at 158. Route optimization at 160 aims to ensure that the design meets all performance and manufacturability requirements and further aims to achieve timing closure by fixing timing violations (e.g., by optimizing wire lengths, buffer placements, and net delays).

At 162, process 150 performs zero-mean shifting and at 164, process 150 performs a clock latency constraints check. In one or more embodiments, the zero-mean shifting 162 is performed in accordance with process 100 of FIG. 1A. Upon completion of the zero-mean shifting at 162, a new clock latency set

$$( e . g . , L = {[ {L}_{1}^{new} , {L}_{2}^{new} , … , {L}_{N}^{new} ]}^{T} )$$

and a set of clock latency constraints

$$( e . g . , {L}_{i}^{min} \leq {L}_{i} \leq {L}_{i}^{max} , ∀ i = 1 , … , N )$$

are utilized for a subsequent iteration of process 150—which can be repeated in an iterative fashion to optimize chip design.

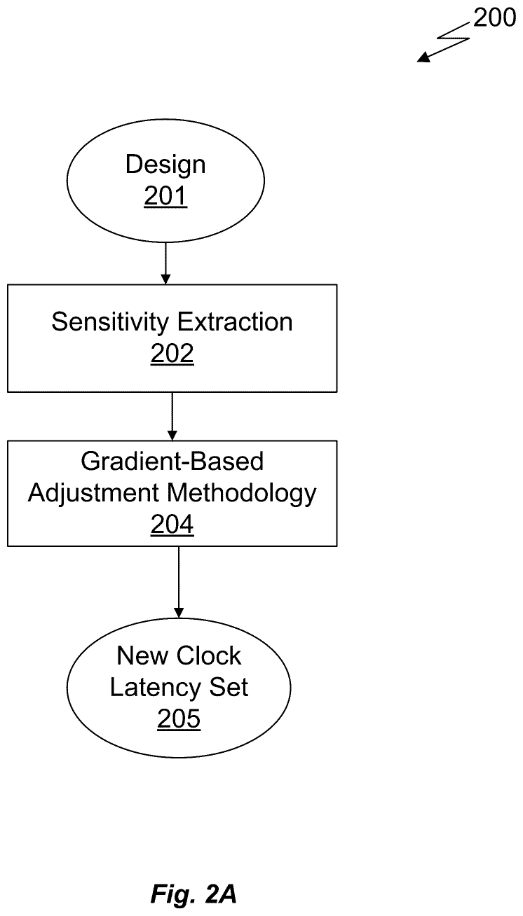

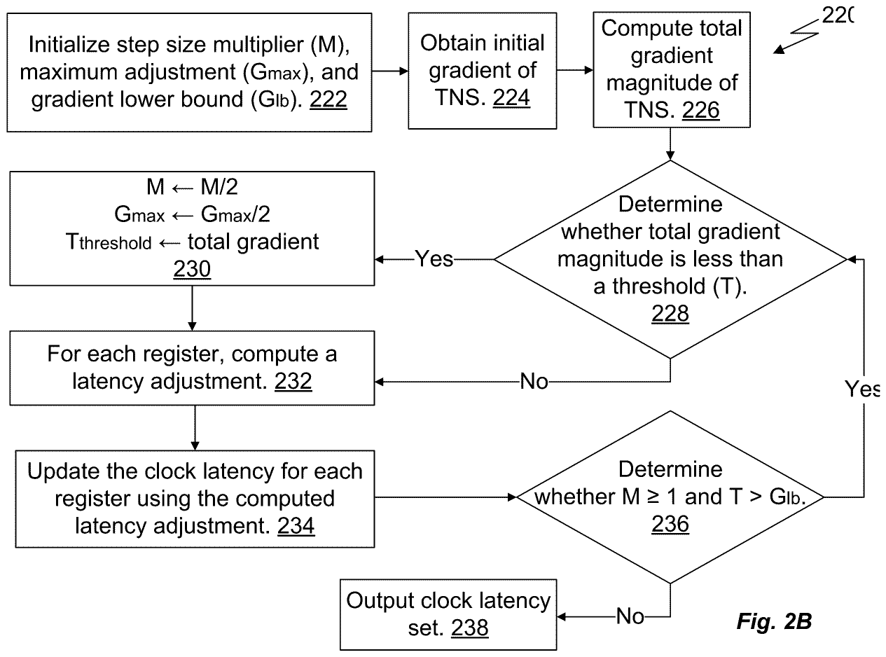

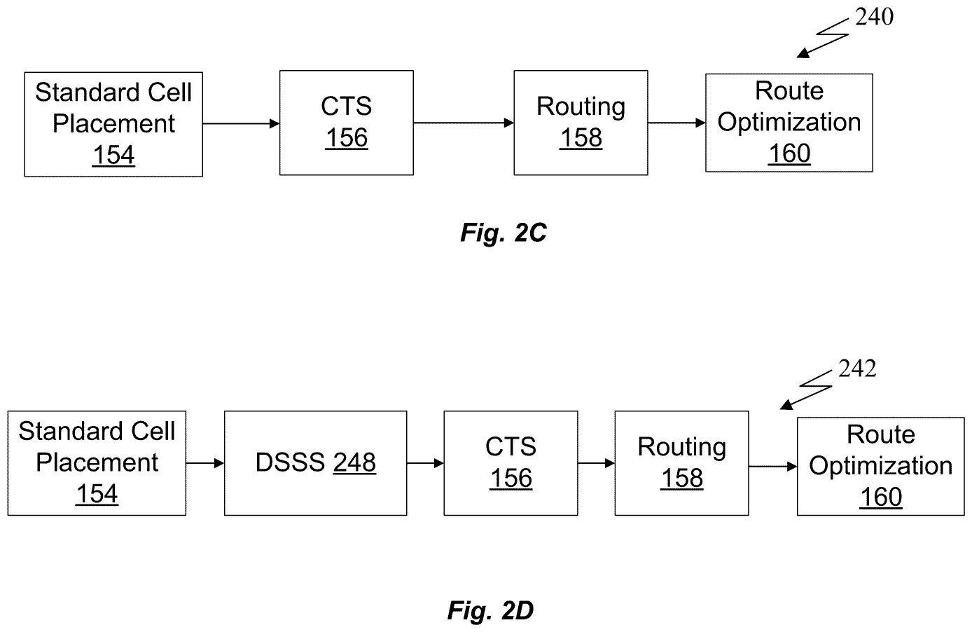

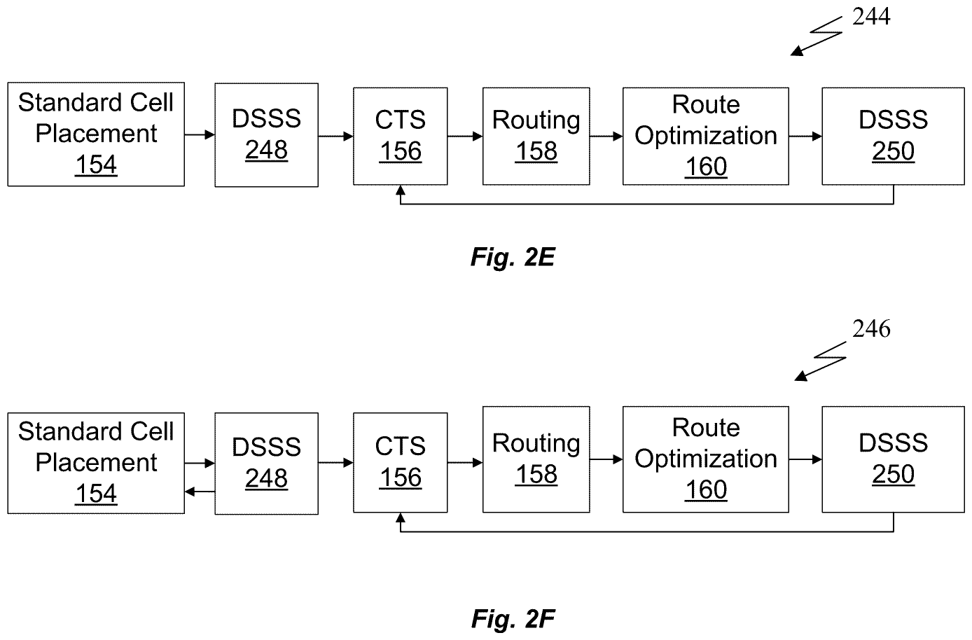

FIG. 2A illustrates a flowchart of a process 200 for implementing a Differentiable Sensitivity-Based Skew Scheduling (DSSS) technique, in accordance with an embodiment of the present disclosure. Each block of process 200, described herein, comprises a computing process that may be performed using any combination of hardware, firmware, and/or software. For instance, various functions may be carried out by a processor executing instructions stored in memory. The process may also be embodied as computer-usable instructions stored on computer storage media. The process may be provided by a standalone application, a service or hosted service (standalone or in combination with another hosted service), or a plug-in to another product, to name a few. However, this process may additionally or alternatively be executed by any one system, or any combination of systems, including, but not limited to, those described herein. Furthermore, persons of ordinary skill in the art will understand that any system that performs process 200 is within the scope and spirit of embodiments of the present disclosure.

Process 200 receives, as input, chip design 201. Process 200 adjusts the clock latencies L=[L₁, L₂, . . . , L_{N}]^{T} at N registers in the chip design 201 via gradient-based techniques to solve an optimization problem and thereby provide a new clock latency set 205, which includes new clock latencies

$$L = {[ {L}_{1}^{new} , {L}_{2}^{new} , … , {L}_{N}^{new} ]}^{T} .$$

At 202, process 200 formulates an optimization problem that models the relationship between the clock latencies L=[L₁, L₂, . . . , L_{N}]^{T} and timing metrics in a differentiable manner. In at least one embodiment, the optimization problem is:

$${Minimize}_{L} V ( L ) = {\sum }_{k} max ( 0 , - {Slack}_{k} )$$

$$Subject to {L}_{i}^{min} \leq {L}_{i} \leq {L}_{i}^{max} , ∀ i = 1 , … , N$$

where |V(L)| represents the TNS for the given clock latency set L, max (0,−Slackₖ) represents the contribution of timing path k to the TNS, Slackₖ is the slack of timing path k, defined based on the clock latencies and path delays, and

$${L}_{i}^{min} and {L}_{i}^{max}$$

are the minimum and maximum allowable clock latencies for register i, representing physical and design constraints. In one or more alternative embodiments, the timing metric can be, e.g., WNS or a function of both TNS and WNS.

In at least one embodiment, process 200 formulates, at 202, Slackₖ as a function of the clock latencies L and derives the gradient of V(L) with respect to L. Specifically, for each timing path k from a source register q to a destination register p, the setup slack is defined as:

$${Slack}_{k} = T + ( {L}_{p} - {L}_{q} ) - {t}_{pd , k} - {t}_{setup , p} ,$$

where T is the clock period, Lₚ and L_{q} are the clock latencies at registers p and q, respectively, t_{pd,k} is the data path delay of path k, t_{setup,p} is the setup time of register p. Slackₖ can then be expressed as a linear function of clock latencies:

$${Slack}_{k} = {R}_{k}^{T} L + {c}_{k} ,$$

where Rₖ∈ [symbol] is a vector with elements:

$${( {R}_{k} )}_{i} = \{ \begin{matrix}+ 1 , & if i = p , \\ - 1 , & if i = q , \\ 0 , & otherwise ,\end{matrix}$$

cₖ=T−tp_{d,k}−t_{setup,p} is a constant for path k. The objective function V(L) is convex since it is a sum of convex functions. The feasible set defined by

$${L}_{i}^{min} \leq {L}_{i} \leq {L}_{i}^{max} ,$$

∀i=1, . . . , N is also convex, making the optimization problem a convex optimization problem.

To enable gradient-based optimization, process 200 utilizes, at 202, a smooth, differentiable function for the penalty function. In at least one embodiment, process 200 utilizes the Softplus function to approximate the penalty function max(0,−Slackₖ), which is not differentiable at Slackₖ=0. Utilizing the Softplus function to approximate max(0,−Slackₖ) provides:

$$f ( {Slack}_{k} ) = \frac{1}{α} ln ( 1 + {e}^{- α \cdot {Slack}_{k}} ) ,$$

where α>0 is a smoothing parameter controlling the approximation accuracy. As α→∞, f(Slackₖ) approaches max(0,−Slackₖ). The gradient of the objective function with respect to the clock latencies is:

$$∇ V ( L ) = {\sum }_{k} {f}^{′} ( {Slack}_{k} ) {∇}_{L} {Slack}_{k} ,$$

where f′(Slackₖ) is the derivative of the penalty function, and ∇_{L} Slackₖ is:

$${∇}_{L} {Slack}_{k} = {R}_{k} .$$

For the Softplus function, the derivative becomes:

$${f}^{′} ( {Slack}_{k} ) = - \frac{1}{1 + {e}^{α \cdot {Slack}_{k}}} .$$

Using the gradient, the clock latencies can be iteratively updated according to:

$${L}^{( t + 1 )} = {L}^{( t )} - {η}^{( c )} ∇ V ( {L}^{( t )} ) ,$$

where η^{(t)} is the step size at iteration t. After each update, the latencies L^{(t+1)} can be projected onto the feasible set of latencies defined by

$${L}_{i}^{min} \leq {L}_{i} \leq {L}_{i}^{max} ,$$

∀i=1, . . . , N, thereby providing:

$${L}_{i}^{( t + 1 )} = min ( {L}_{i}^{max} , max ( {L}_{i}^{min} , {L}_{i}^{( t + 1 )} ) ) .$$

Since the problem is convex and the objective function is differentiable (e.g., as a result of approximating it with the Softplus function), gradient-based processes will converge to the global minimum under appropriate step size conditions.

Process 200 performs gradient-based clock latency adjustment at 204. The gradient-based clock latency adjustment at 204 begins by initializing hyperparameters, e.g., a step size multiplier M, a maximum adjustment per iteration Gₘₐₓ, and a gradient lower bound G_{lb}. Then, a plurality of gradient-based clock latency adjustment iterations are performed, each of which includes (a) sensitivity extraction and (b) latency adjustment.

Sensitivity extraction involves extracting sensitivity information for each register. Sensitivity is defined as the rate of change in a timing metric (e.g., TNS) with respect to clock latency changes at each register. The extracted sensitivities are used to determine subsequent clock latency adjustments. In at least one embodiment, extracting sensitivity information for each register includes (i) initializing a static timing analysis (STA) framework with a commercial place-and-route tool, (ii) designating clock arrival times at each register of the chip design 201 (i.e., the set of latencies L=[L₁, L₂, . . . , L_{N}]^{T} at the N registers in the chip design 201) as leaf optimization variables, and (iii) computing the gradient of a timing metric (e.g., TNS) with respect to each leaf optimization variable (i.e., with respect to each latency Lᵢ). In at least one embodiment, sensitivity information is extracted using a GPU-accelerated, differentiable static timing analysis (STA) framework. In at least one embodiment, the sensitivity information is extracted using a GPU-accelerated STA framework (e.g., the INSTA framework of NVIDIA).

Latency adjustment, performed after sensitivity extraction in each iteration, involves determining a clock latency adjustment ΔLᵢ for each register i=1, 2, . . . , N in chip design 201. The clock latency adjustments are computed using the extracted sensitivity information (i.e., the gradient of the timing metric with respect to each latency Lᵢ). After the clock latency adjustments are computed, they are applied to the latencies L=[L₁, L₂, . . . , L_{N}]^{T} to provide, for each latency Lᵢ, a new latency

$$L = {[ {L}_{1}^{new} , {L}_{2}^{new} , … , {L}_{N}^{new} ]}^{T}$$

A new Clock latency set

$${L}_{i}^{new} = {L}_{i} + Δ {L}_{i} .$$

is thereby provided. A convergence criteria is assessed using the new clock latencies, and if the convergence criteria is not satisfied, another iteration of gradient-based clock latency adjustment is performed. If the convergence criteria is satisfied, the process outputs the new clock latency set as new clock latency set 205.

In at least one embodiment, the gradient-based adjustment methodology at 204 employs the gradient-based clock latency adjustment algorithm as shown in FIG. 2B. In each iteration, the gradients are obtained from a GPU-accelerated STA framework (e.g., the INSTA framework of NVIDIA), and the total gradient magnitude (T) is computed. If the new gradient magnitude is significantly smaller than the previous value, the adjustment factors are scaled down to maintain stability and prevent oscillatory behavior. Clock latencies are updated for each register based on the extracted gradient, scaled by M. The adjustments are capped by Gₘₐₓ to avoid excessively large changes that could destabilize other timing paths. The iterations continue until convergence, ensuring balanced clock distribution and improved timing margins.

FIG. 2B illustrates a flowchart of a process 220 for implementing a Differentiable Sensitivity-Based Skew Scheduling (DSSS) technique, in accordance with an embodiment of the present disclosure. Each block of process 220, described herein, comprises a computing process that may be performed using any combination of hardware, firmware, and/or software. For instance, various functions may be carried out by a processor executing instructions stored in memory. The process may also be embodied as computer-usable instructions stored on computer storage media. The process may be provided by a standalone application, a service or hosted service (standalone or in combination with another hosted service), or a plug-in to another product, to name a few. However, this process may additionally or alternatively be executed by any one system, or any combination of systems, including, but not limited to, those described herein. Furthermore, persons of ordinary skill in the art will understand that any system that performs process 220 is within the scope and spirit of embodiments of the present disclosure.

At 222, process 220 initializes hyperparameters such as step size multiplier (M), maximum adjustment (Gₘₐₓ), and gradient lower bound (G_{lb}).

At 224, process 220 obtains an initial gradient of the TNS. In one or more embodiments, process 220 obtains the initial gradient of the TNS with respect to clock latencies via a GPU-accelerated STA framework (e.g., the NVIDIA INSTA framework). The initial gradient vector g indicates the sensitivity of the TNS to changes in clock latencies and can be represented as:

$$g = {[ {g}_{1} , {g}_{2} … {g}_{N} ]}^{T}$$

At 226, process 220 computes a total gradient magnitude (T) of the TNS. In one or more embodiments, the total gradient magnitude is computed by adding the magnitude of all the gradients that are part of the gradient vector G. In one or more embodiments, the total gradient magnitude (T) is computed as:

$$T ← {\sum }_{i = 1}^{N} \vert {g}_{i} \vert .$$

At 228, process 220 determines whether the total gradient magnitude (T) is less than a threshold. In response to determining that the total gradient magnitude (T) is less than the threshold, the process 220 modifies the initialized parameters. In one or more embodiments, the threshold is predefined as a factor of a threshold gradient value (T_{threshold}), such as, 0.1×T_{threshold}, or 0.2×T_{threshold}, or any other factor of the threshold gradient value (T_{threshold}). Upon determining that the total gradient magnitude (T) is less than the threshold, the process 220 reduces the step size multiplier (M) to half its original value and stores the reduced step size multiplier (M/2) as the new step size multiplier. Additionally, the process 220 reduces the maximum adjustment (Gₘₐₓ) to half its original value and stores the reduced maximum adjustment (Gₘₐₓ/2) as the new maximum adjustment. Process 220 also updates the previously computed threshold gradient value (T_{threshold}), that is used to compute the threshold with the total gradient magnitude (T). In one or more embodiments, the process 220 uses the updated Tₚᵣₑᵥᵢₒᵤₛ to compute a new threshold for a subsequent iteration. After process 220 adjusts the initialized hyperparameters, process 220 proceeds to 232 to compute a latency adjustment (ΔLᵢ) for each register (i).

Additionally and/or alternatively, in response to determining that the total gradient magnitude is greater than the threshold, the process 220 proceeds to 232 to compute a latency adjustment (ΔLᵢ) for each register (i). In order compute the latency adjustment (ΔLᵢ), the process 220 scales each respective computed gradient (g) using the step size multiplier. The process 220, at 232, also normalizes each respective scaled gradient (gᵢ) using the mean gradient parameter (gₘₑₐₙ). The latency adjustment (ΔLᵢ), based on the gradient of the TNS with respect to the latency, is capped at Gₘₐₓ to prevent excessively large updates. In one or more embodiments, the latency adjustments (e.g., scaling and normalizing) are represented using the following equation:

$$Δ {L}_{i} ← min ( \frac{M \times {g}_{i}}{{g}_{mean}} , {G}_{max} )$$

At 234, the process 220 updates the clock latency (Lᵢ) for each register (i) using the calculated updated latency (ΔLᵢ). For example, the latency associated with a register is updated by adding the latency adjustment calculated at 232 to the already existing latency of the register. This is represented using the following equation:

$${L}_{i} ← {L}_{i} + Δ {L}_{i}$$

At 236, process 220 determines whether the step size multiplier (M) is greater than or equal to 1 and the threshold gradient value (T_{threshold}) is greater than the gradient lower bound (G_{lb}). Based on determining that either the step size multiplier (M) is less than 1 or the threshold gradient value (T_{threshold}) is less than the gradient lower bound (G_{lb}), the process 220 proceeds to 238 to output the clock latency set.

Alternatively, if process 220 determines that the step size multiplier (M) is greater than equal to 1 and the threshold gradient value (T_{threshold}) is greater than the gradient lower bound (G_{lb}), process 220 proceeds to perform another iteration by determining whether the total gradient magnitude is less than the threshold.

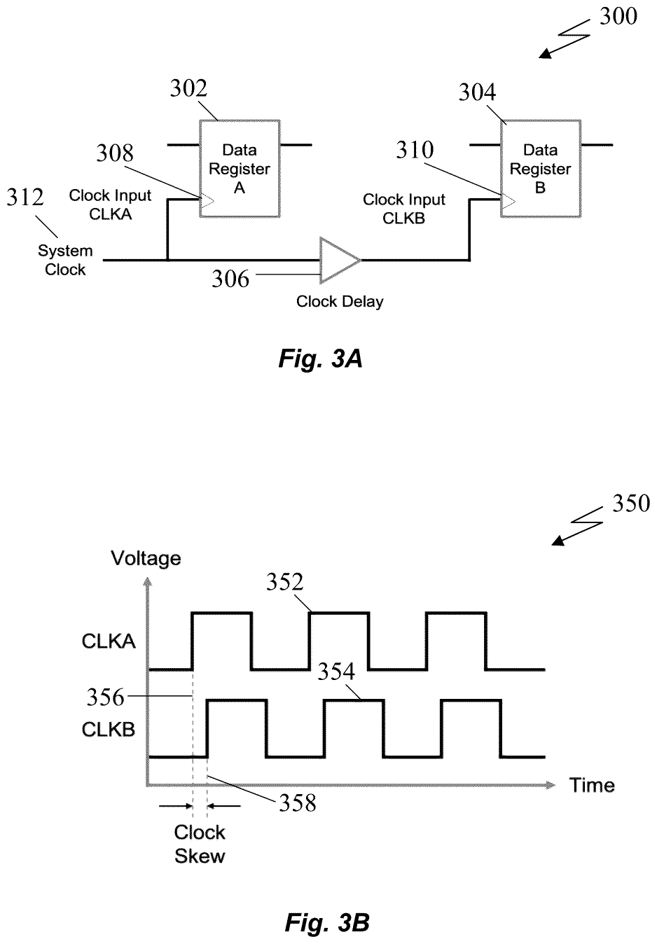

In various embodiments, process 200 is performed in the context of a “place-and-route” design flow of an electronic design automation (EDA) process, e.g., as carried out using a commercial EDA tool. The “place-and-route” design flow includes (i) macro placement, (ii) standard cell placement, (iii) clock tree synthesis (CTS), (iv) routing, and (v) route optimization. The position of process 200 in the overall place-and-route design flow can vary. Different overall place-and-route design flows that incorporate process 200 are discussed with respect to FIGS. 3A-3B.

FIG. 2C-2F illustrates a place-and-route design flows 240, 242, 244, and 246 of an electronic design automation (EDA) process using a commercial EDA tool that incorporates DSSS, according to embodiments of the present disclosure.

Design flow 240, as shown in FIG. 2C, illustrates a default place-and-route design flow of the electronic design automation (EDA) process. In one or more embodiments, the design flow 240 includes (i) standard cell placement 154, (ii) clock tree synthesis (CTS) 156, (iii) routing 158, and (iv) route optimization 160. The functioning of these components is discussed with respect to FIG. 1B.

Design flow 242, as shown in FIG. 2D, illustrates a one-shot optimization performed as part of the place-and-route design flow in which the DSSS 248 is incorporated before CTS 156. Incorporating the DSSS 248 before CTS 156 significantly enhances timing performance. Additionally, because the clock latency generation process is efficient, the inclusion of the DSSS 248 within the place-and-route design flow 240 adds negligible runtime overhead to the overall design flow. The one-shot optimization as depicted in design flow 242, achieves an average WNS reduction of 13.40% and a TNS reduction of 21.87% compared to the default place-and-route design flow 240, as shown in FIG. 2C.

Design flow 244, as shown in FIG. 2E, illustrates a place-and-route design flow similar to design flow 242 but includes an additional back annotation flow using a second instance of DSSS 250 positioned after the route optimization 160. In accordance with embodiments of the present disclosure, the design flow 244 allows for the second instance of DSSS 250 to provide feedback from the post-route stage after route optimization 160 to CTS 156. This achieves a greater reduction of worst negative slack (WNS) and a total negative slack (TNS) as compared to the design flow 242 as shown in FIG. 2D. The design flow 244, with the back annotation flow, achieves a WNS reduction of 22.18% and a TNS reduction of 43.09% compared to the default place-and-route design flow 240, as shown in FIG. 2C.

Design flow 246, as shown in FIG. 2F, illustrates a place-and-route design flow similar to design flow 244 but also utilizes the DSSS 248 to optimize the placement of standard objects performed by the EDA during standard cell placement 154. In some embodiments, the DSSS 248 performs up to five placement feedback iterations to modify the placement of standard objects performed by the EDA applying sensitivity analysis during the post-placement stage to iteratively refine the placement and timing co-optimization. The design flow 246, with the DSSS 248 to optimize the placement of standard objects performed by the EDA during standard cell placement 154, achieves a WNS reduction of 24.16% and a TNS reduction of 45.88% compared to the default place-and-route design flow 240, as shown in FIG. 2C.

FIGS. 3A-3B illustrate clock skew in a synchronous digital circuit.

FIG. 3A includes a first circuit diagram 300 that depicts an exemplary portion of a digital circuit with a first flip-flop 302 and a second flip-flop 304. Data from the first flip-flop 302 (e.g., the transmitting register) is transmitted to the second flip-flop 304 (e.g., the receiving register). The first flip-flop 302 receives a clock signal 312 at clock input A 308 and the second flip-flop 304 receives the clock signal 312 at clock input B 310. In this case shown in FIG. 3A, the clock signal 312 arriving at the second flip-flop 304 is delayed by using a clock delay element 306. Because the second flip-flop 304 receives the clock signal 312 after the first flip-flop 310 receives the clock signal 312, this creates a positive clock skew. In some embodiments, a positive clock skew is introduced between the first-flop 302 and the second flip-flop 304 to allow time for data to travel from the first flip-flop 302 to the second flip-flip 304 in order to avoid timing violations at the second flip-flop 304.

FIG. 3B depicts a timing diagram 350 including clock signals having a positive skew. Timing diagram 350 of FIG. 3B includes a curve 352 and a curve 354 that indicates the arrival of the clock signal 312 at the first flip-flop 302 and at the second flip-flop 304 respectively. As seen in timing diagram 350, a first rising edge of the clock signal 312 arrives at the first flip-flop 302 at time 356. Similarly, a first rising edge of the clock signal 312, arrives at the second flip-flop 304 at time 358. As time 358 is later than the time 356, there is a positive skew created between the first flip-flop 302 and the second flip-flop 304.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

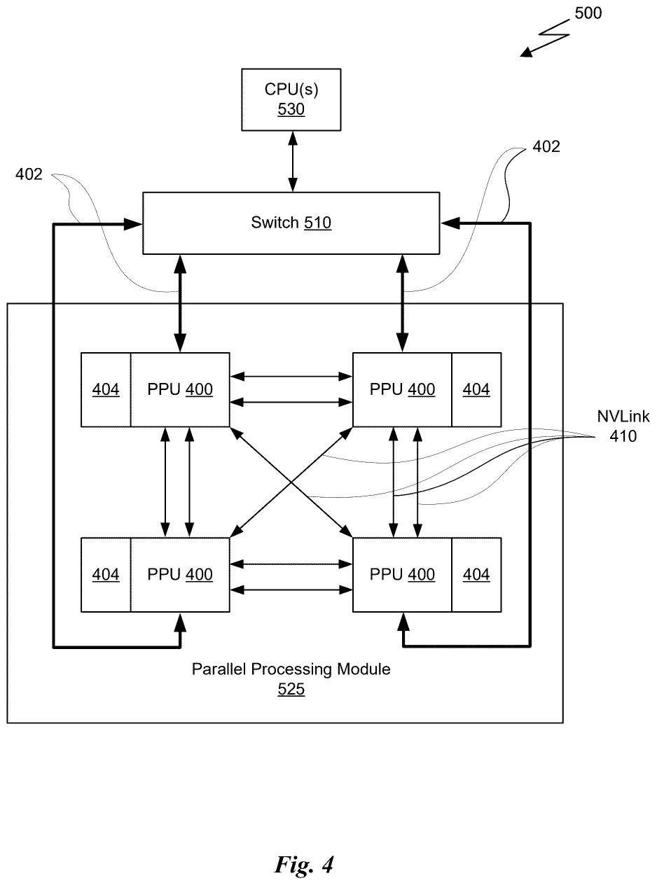

FIG. 4 is a conceptual diagram of a processing system 500 implemented using multiple PPUs 400, in accordance with an embodiment. The exemplary system 500 may utilized as a particular node—or portion thereof—in the above-described multi-node computing systems. In addition to the multiple PPUs 400, the processing system 500 includes a CPU 530, switch 510, and respective memories 404 for the PPUs 400.

Each parallel processing unit (PPU) 400 may include hundreds or thousands of cores that are capable of handling hundreds or thousands of software threads simultaneously. The PPUs 400 may generate pixel data for output images in response to rendering commands (e.g., rendering commands from the CPU(s) 530 received via a host interface). The PPUs 400 may include graphics memory, such as display memory, for storing pixel data or any other suitable data, such as GPU data. The display memory may be included as part of the memory 404. The PPUs 400 may include two or more GPUs operating in parallel (e.g., via a link). The link may directly connect the GPUs (e.g., using NVLINK 410) or may connect the GPUs through a switch (e.g., using switch 510). When combined together, each PPU 400 may generate pixel data or GPGPU data for different portions of an output or for different outputs (e.g., a first PPU for a first image and a second PPU for a second image). Each PPU 400 may include its own memory 404, or may share memory with other PPUs 400.

The PPUs 400 may each include, and/or be configured to perform functions of, one or more processing cores and/or components thereof, such as Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The NVLink 410 provides high-speed communication links between each of the PPUs 400. Although a particular number of NVLink 410 and interconnect 402 connections are illustrated in FIG. 4, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 4, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 4, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

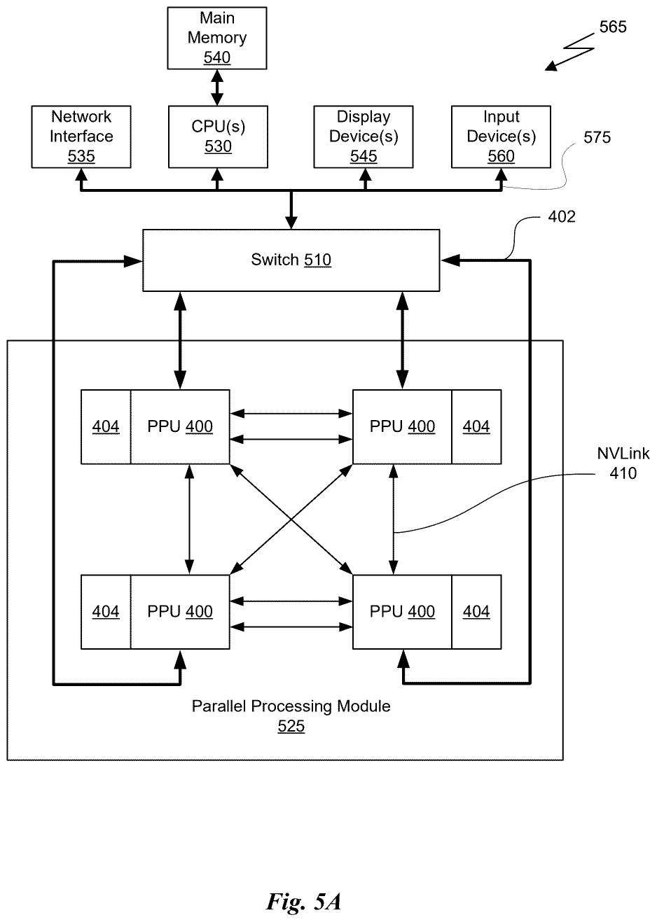

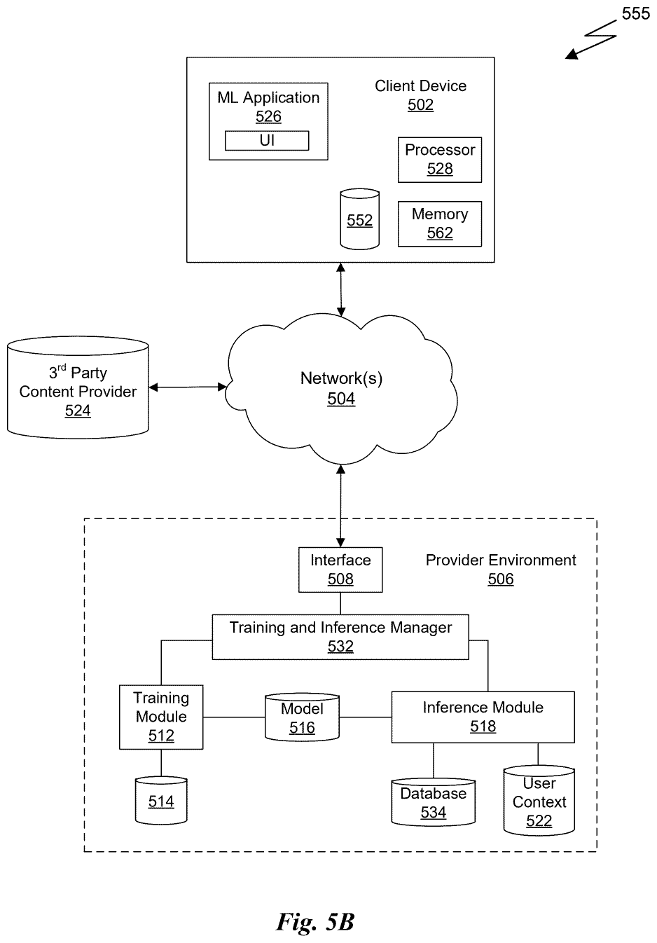

FIG. 5A illustrates an exemplary system 565 in which the various architecture and/or functionality of the various previous embodiments may be implemented. The exemplary system 565 may be configured to implement the process 300 shown in FIG. 3.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5A are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5A is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5A.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may be implemented as a network interface controller (NIC) that includes one or more data processing units (DPUs) to perform operations such as (for example and without limitation) packet parsing and accelerating network processing and communication. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 4 and/or exemplary system 565 of FIG. 5A—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment- and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 4 and/or exemplary system 565 of FIG. 5A. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron is the most basic model of a neural network. In one example, a neuron may receive one or more inputs that represent various features of an object that the neuron is being trained to recognize and classify, and each of these features is assigned a certain weight based on the importance of that feature in defining the shape of an object.

A deep neural network (DNN) model includes multiple layers of many connected nodes (e.g., neurons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5B illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506. In at least one embodiment, supervised and/or unsupervised training can be performed by the client device 502 and/or the provider environment 506. In at least one embodiment, a set of training data 514 (e.g., classified or labeled data) is provided as input to function as training data.

In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA Geforce Now (GFN), Google Stadia, and the like.

### Example Streaming System

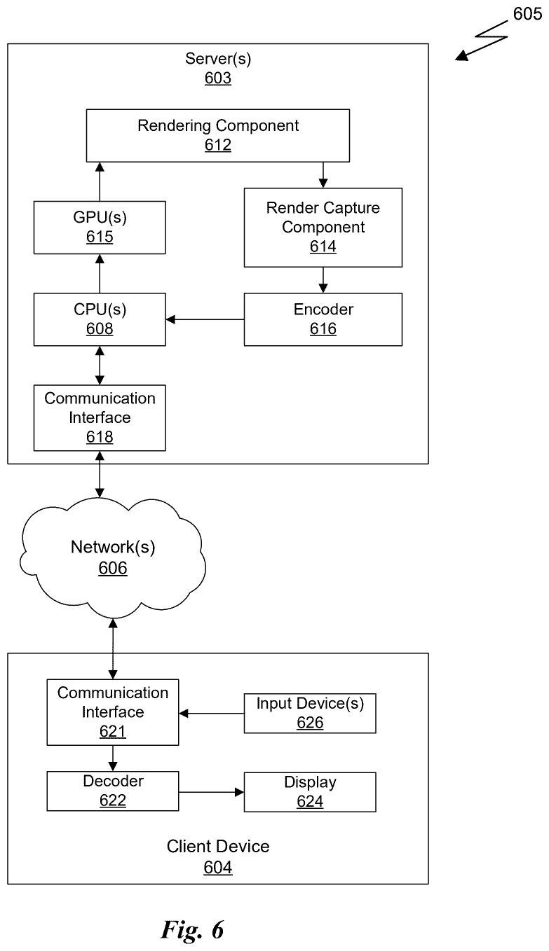

FIG. 6 is an example system diagram for a streaming system 605, in accordance with some embodiments of the present disclosure. FIG. 6 includes server(s) 603 (which may include similar components, features, and/or functionality to the example processing system 500 of FIG. 4 and/or exemplary system 565 of FIG. 5A), client device(s) 604 (which may include similar components, features, and/or functionality to the example processing system 500 of FIG. 4 and/or exemplary system 565 of FIG. 5A), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering—in particular ray or path tracing—for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units—such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

The arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. Various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A computer-implemented method for clock latency adjustment, comprising:
obtaining a clock latency set and a timing report;
identifying, based on the clock latency set and the timing report, a set of critical registers;
performing an initial clock latency adjustment procedure to provide one or more latency adjustments for one or more critical registers in the set of critical registers;
modifying, pursuant to a zero-mean constraint, the one or more latency adjustments; and
adjusting, using the one or more modified latency adjustments, one or more latencies in the clock latency set.

2. The computer-implemented method according to claim 1, wherein each critical register of the set of critical registers is part of a corresponding timing-violated path, and wherein each critical register of the set of critical registers has a negative slack associated with the corresponding timing-violated path.

3. The computer-implemented method according to claim 2, wherein performing the initial clock latency adjustment procedure to provide the latency adjustment comprises:
determining the latency adjustment for the one or more critical registers based on the negative slacks associated with the one or more critical registers.

4. The computer-implemented method according to claim 1, wherein modifying the one or more latency adjustments further comprises:
determining whether a first modified latency adjustment of the one or more modified latency adjustments is feasible by comparing a first clock latency of a corresponding capturing register of the one or more critical registers, associated with the first modified latency adjustment, with a second clock latency of a corresponding launching register of the one or more critical registers, associated with the first modified latency adjustment; and
updating the first modified latency adjustment based on determining that the first clock latency is less than the second clock latency.

5. The computer-implemented method according to claim 4, further comprising:
adjusting, using the first modified latency adjustment, the one or more latencies in the clock latency set to provide a new clock latency set based on determining that the first clock latency is greater than or equal to the second clock latency.

6. A computer-implemented method for clock latency adjustment, comprising:
obtaining a clock latency set including a latency for one or more registers in a chip design;
obtaining a timing metric function of the clock latency set; and
updating the clock latency set by performing, for each of one or more iterations:
computing one or more gradients of the timing metric function with respect to one or more latencies in the clock latency set;
computing, based on the one or more computed gradients, a clock latency adjustment for the one or more latencies in the clock latency set; and
adjusting, using the one or more computed clock latency adjustments, the one or more latencies in the clock latency set.

7. The computer-implemented method according to claim 6, further comprising initializing, before the one or more iterations, hyperparameters including a step size multiplier (M), a maximum adjustment per iteration (Gₘₐₓ) and a lower gradient bound (G_{lb}).

8. The computer-implemented method according to claim 7, wherein computing the gradient of the timing metric function with respect to the one or more latencies comprises:
initializing a static timing analysis framework (STA) within a place-and-route tool;
designing clock arrival times at the one or more registers as leaf optimization variables; and
computing a respective gradient of the timing metric function with respect to each leaf optimization variable.

9. The computer-implemented method of claim 8, wherein computing the gradient of the timing metric function further comprises determining a total gradient by adding respective gradients associated with the leaf optimization variables.

10. The computer-implemented method of claim 9, wherein computing the clock latency adjustment comprises:
determining the total gradient is less than a reference total gradient value; and
based on determining the total gradient is less than the reference total gradient value:
reducing the step size multiplier (M) and the maximum adjustment per iteration (Gₘₐₓ) by a predetermined factor; and
updating the reference total gradient value to equal the determined total gradient.

11. The computer-implemented method of claim 10, wherein computing the clock latency adjustment further comprises:
scaling each respective computed gradient using the reduced step size multiplier; and
normalizing each respective scaled gradient using a mean gradient parameter (gₘₑₐₙ).

12. The computer-implemented method of claim 11, wherein the mean gradient parameter is an average of the respective gradients.

13. The computer-implemented method of claim 12, further comprising terminating the one or more iterations based on determining that the step size multiplier (M) is less than a predetermined threshold.

14. The computer-implemented method of claim 12, further comprising terminating the one or more iterations based on determining that the reference total gradient is less than the lower gradient bound (G_{lb}).

15. A system for clock latency adjustment, the system comprising:
processing circuitry configured to:
obtain a clock latency set and a timing report;
identify, based on the clock latency set and the timing report, a set of critical registers;
perform an initial clock latency adjustment procedure to provide one or more latency adjustments for one or more critical registers in the set of critical registers;
modify, pursuant to a zero-mean constraint, the one or more latency adjustments; and
adjust, using the one or more modified latency adjustments, one or more latencies in the clock latency set.

16. The system according to claim 15, wherein each critical register of the set of critical registers is part of a corresponding timing-violated path, and wherein each critical register of the set of critical registers has a negative slack associated with the corresponding timing-violated path.

17. The system according to claim 16, wherein processing circuitry, configured to perform the initial clock latency adjustment procedure to provide the one or more latency adjustments, is further configured to:
determine the latency adjustment for the one or more critical registers based on the negative slacks associated with the one or more critical registers.

18. A system for clock latency adjustment, the system comprising:
processing circuitry configured to:
obtain a clock latency set including a latency for one or more registers in a chip design;
obtain a timing metric function of the clock latency set; and
update the clock latency set by performing, for each of one or more iterations:
compute a gradient of the timing metric function with respect to one or more latencies in the clock latency set;
compute, based on the one or more computed gradients, one or more clock latency adjustments for the one or more latencies in the clock latency set; and
adjust, using the one or more computed clock latency adjustments, the one or more latencies in the clock latency set.

19. The system according to claim 18, wherein the processing circuitry is further configured to:
initialize, before the one or more iterations, hyperparameters including a step size multiplier (M), a maximum adjustment per iteration (Gₘₐₓ) and a lower gradient bound (G_{lb}).

20. The system according to claim 19, wherein the processing circuitry, configured to compute the gradient of the timing metric function with respect to the one or more latencies, is further configured to:
initialize a static timing analysis framework (STA) within a place-and-route tool;
design clock arrival times at the one or more registers as leaf optimization variables; and
compute a respective gradient of the timing metric function with respect to each leaf optimization variable.
